(19) United States
(12) Patent Application Publication
(10) Pub. No.: US 2008/0160629 A1
(43) Pub. Date: Jul. 3, 2008

(54) METHODS AND SYSTEMS FOR OFF-LINE MULTIDIMENSIONAL CONCENTRATION AND SEPARATION OF BIOMOLECULES

(75) Inventor: Brian M. Balgley, Annandale, VA (US)

Correspondence Address: PILLSBURY WINTHROP SHAW PITTMAN, LLP, P.O. BOX 10500, MCLEAN, VA, 22102, US

(73) Assignee: Calibrant Biosystems, Inc., Rockville, MD (US)

(21) Appl. No.: 11/619,041

(22) Filed: Jan. 2, 2007

(51) Int. Cl. G01N 30/02; B01D 57/02

(52) U.S. Cl. 436/161; 204/451; 204/455

(57) ABSTRACT

The invention provides a method for performing off-line multi-dimensional separation and analysis of a heterogeneous biomolecular sample. The method includes separating the heterogeneous biomolecular sample into a plurality of fractions using an electrophoresis capillary. The plurality of fractions are then deposited onto one or more structures, which keep each of the plurality of fractions separate from one another. The plurality of fractions are then subjected to non-eluting conditions by titrating the at least one of the plurality of fractions to an acidic pH and adding an ion-pairing reagent to the fractions. At least one of the fractions is then introduced into a capillary reversed-phase electrophoresis capillary. The fraction is then separated in the capillary into a plurality of sub-fractions based on hydrophobicity of the sub-fractions. The sub-fractions are then analyzed to determine their constituent molecules.

### CROSS-REFERENCE TO RELATED APPLICATIONS

This application is related to co-pending U.S. Patent Application No. (Attorney Docket No. 016474-0358903), entitled “Methods and Systems for Multidimensional Concentration and Separation of Biomolecules using Capillary lsotachophoresis” filed herewith, which is hereby incorporated by reference herein in its entirety.

### STATEMENT REGARDING FEDERALLY SPONSORED RESEARCH

The U.S. Government may have certain rights in this invention as provided for by the terms of Grant Numbers R43 CA103086, R44 CA107988, and R44 RR022667 awarded by the National Institutes of Health.

### FIELD OF THE INVENTION

The invention relates generally to a method for multidimensional separation of biomolecules using orthogonal separation techniques and more particularly to a method for multidimensional separation using electrophoresis in the first dimension, off-line transfer of samples to the second dimension, and liquid chromatography in the second dimension.

### BACKGROUND

Identification and analysis of biomolecules is crucial for modern scientific discovery. Identification and analysis of proteins and other peptides is especially important, as proteomic analysis provides practical information regarding cellular function. While genomic analysis provides an abstracted view of the probable organization and function of biological systems, proteomic analysis enables a practical understanding of actual gene expression, enables identification and study of active biological pathways, and otherwise provides useful information regarding actual functioning of biological systems.

Proteomic analysis in the field of cancer is particularly important. Predictions of cancer behavior and likely drug response and resistance have been confounded by the great complexity of the human genome and, very often, the cellular heterogeneity of tumors. While analyses of DNA and RNA expression profiles through techniques including cDNA microarrays, comparative genomic hybridization, loss of heterozygosity (LOH), and single nucleotide polymorphism (SNP) analysis are important in identifying genetic abnormalities and uncovering the molecular dysfunctions existing in tumor cells, the presence of SNPs, changes in DNA copy numbers, or altered RNA levels may have little or no effect on the events actually happening at the protein level. Although many genes are possibly associated with the onset, progression, and/or severity of cancer, the specific roles played by the majority of these genes are yet to be clearly elucidated at the protein level, and only a small number have been clinically validated or associated with clinical phenotype.

Proteomics will therefore contribute greatly to our understanding of gene function in the post-genomics era, impacting disease related research from early diagnosis to the identification of targets for drug screening and development. However, biologically relevant proteomics data can best be generated if the samples investigated consist of homogeneous cell populations, in which no unwanted cells of different types and/or development stages obscure the results. Thus, technologies such as laser capture microdissection (LCM) technology have been developed to provide a rapid and straightforward method for procuring homogeneous subpopulations of cells for biochemical and molecular biological analyses. In the absence of PCR-like protein amplification techniques, current proteome platforms, including two-dimensional polyacrylamide gel electrophoresis (2-D PAGE) and shotgun-based multidimensional liquid chromatography separations, require substantially larger cellular samples which are generally incompatible with protein extract levels obtained from small cell populations and limited tissue samples. While limited 2-D PAGE analyses of microdissection-derived tissue samples have been attempted, these studies require significant manual effort and time to extract sufficient levels of protein for analysis, while providing little information on protein expression beyond a relatively small number of high abundance proteins. In addition, the 2-D PAGE-MS approach itself suffers from low throughput and poor reproducibility, and remains lacking in proteome coverage, dynamic range, and sensitivity.

Shotgun identification of protein mixtures by proteolytic digestion followed with multidimensional liquid chromatography and tandem mass spectrometry (MS) has been used to separate and fragment peptides. Total peak capacity improvements in multidimensional chromatography platforms have increased the number of detected peptides and proteins identified due to better use of the MS dynamic range and reduced discrimination during ionization. To increase the proteome coverage, particularly for the identification of low abundance proteins, these peptide-based proteome technologies often require large quantities of enzymatically/chemically cleaved peptides, ranging from a few milligrams to several hundred micrograms and are generally incompatible with protein levels extracted from microdissection-procured tissue samples. Thus, the reported tissue proteomic studies employing multidimensional liquid chromatography separations are mainly based on the analysis of entire tissue blocks instead of targeted subpopulations of microdissection-derived cells. Additionally, multidimensional liquid phase separations have been employed for the resolution of intact proteins obtained from ovarian carcinoma cell lines.

Cells isolated from fresh frozen tumor tissues have been directly analyzed using matrix-assisted laser desorption/ionization-mass spectrometry (MALDI-MS). The m/z signals or peaks obtained from MALDI-MS are correlated with protein distribution within a specific region of the tissue sample and can be used to construct ion density maps or specific molecular images for virtually every signal detected in the analysis. While surface-enhanced laser desorption/ionization-mass spectrometry (SELDI-MS) has been reported as a relatively simple, rapid, and sensitive protein biomarker analysis tool with potential clinical utility, the transition of protein pattern produced by SELDI-MS to protein identity is generally quite difficult. The efforts typically involve tracking the specific peak of interest through a number of chromatography and gel purification steps to ensure that the peptides measured in the proteolytic digest are mainly derived from the protein of interest. The inherent large-scale and the difficulty of this protein identification process not only accounts for both the small number of proteins identified and the tendency toward the identification of highly abundant proteins, but also calls into question the practicality of the SELDI-MS approach when working with limited clinical samples and microdissected tissue specimens.

In addition to the benefits offered by analytical techniques which are compatible with small sample sizes, effective proteome analysis benefits from techniques that, inter alia, provide high resolution analysis of proteins and which can access a large range of protein abundance. Fortunately, multidimensional separation techniques can serve to reduce the dynamic range of individual fractions of analyte while maintaining high overall separation resolution, especially those techniques that utilize orthogonal separation mechanisms.

LC-LC and LC-CE: Assuming the separation techniques used in the two dimensions are orthogonal, the peak capacity of 2-D separations is the product of the peak capacities of individual one-dimensional methods. Thus, various non-gel-based 2-D separation schemes have been developed to resolve complex peptide/protein mixtures prior to mass spectrometry analysis. In addition to a biphasic microcapillary column packed with strong cation exchange and reversed-phase packing materials several interfaces have been developed for coupling two different modes of LC as well as LC as a first-dimension separation with capillary zone electrophoresis (CZE) in the second dimension.

These interfaces include storage loops, switching valves with two parallel columns, and flow gating. Recently, the use of switching valves has also been adopted for coupling CIEF with capillary electrochromatography (CEC).

CE-LC: In contrast to performing LC prior to a second-dimension electrokinetic separation, LC can follow a first-dimension electrokinetic separation. This modality takes advantage of the high analyte concentration effect possible with electrokinetic separations and couples it with an orthogonal separation mechanism in the form of LC. In order to collect discrete fractions without loss, it is typically necessary to dilute the fraction(s) containing the separated sample. An advantage to using LC as the second-dimension separation mechanism is the ability to perform head-column stacking of the sample during the sample loading process and prior to the LC separation. In this process, the sample binds at the head-end of the column to which it is being loaded and is subject to non-eluting mobile-phase flow conditions such that non-binding salts and other matrices elute to waste. This process allows for near-complete recovery and cleanup of the sample in the diluted fraction prior to the application of a mobile phase eluting gradient flow for the second-dimension separation. It should be noted that head-column stacking may be performed on either the separation column or a pre-column typically referred to as a trap-column.

Direct on-line transfer, has generally been preferred when coupling LC to LC and LC to CE because it is thought to prevent or reduce analyte dilution and sample loss, which can be especially harmful to investigations involving low-abundance proteins. The preference for on-line transfer has also been used in previously demonstrated examples of CE to LC coupling. However, direct transfer from one separation medium to another separation medium can be difficult, especially when the separation techniques used are orthogonal to one another. Because orthogonal separation techniques separate biomolecules based on different properties, these orthogonal techniques often utilize reagents or elements that are incompatible with one another. Biomolecular samples also typically require preparation steps prior to introduction into a separation medium. When multidimensional separations utilize orthogonal separation methods, sample preparation performed in the first dimension is not likely to be compatible with separation in the second dimension. Thus, samples must be re-prepared between separation techniques. This may be extremely difficult to accomplish inside of a direct transfer apparatus. Other difficulties exist in direct sample transfer of analytes in multidimensional separations.

Incompatibility of separation elements, intervening sample prep, and other obstacles have made systems and methods for direct transfer in multidimensional separations complex, expensive, and error prone. For example, in some instances, valving systems may be used for direct or “on-line” transfer between orthogonal, fluid-based separation methods. In some instances, these valves may suffer from deficiencies such as, for example, poor electrical isolation between ports (e.g., electrical crosstalk and current leakage) when high electric fields are used in one or more of the CE separation methods. It may also be difficult to achieve consistent high reliability connections between valving systems and tubing used in one or more of the separation apparatuses used in multidimensional separation. These and other direct transfer methods raise complexity, reliability, cost, and/or other concerns.

As such, an inexpensive and less complex, yet reliable and accurate method for the transfer of analytes between CE and LC separations is desirable.

### SUMMARY OF THE INVENTION

CE-LC separations have exclusively used direct/on-line transfer. The invention utilizes an indirect off-line transfer method for coupled CE-LC separations without incurring substantial analyte dilution or sample loss. Furthermore, the off-line coupling of the invention does not affect the primary advantages of combining CE modes, such as, for example, capillary isoelectric focusing (CIEF), capillary isotachophoresis (CITP), capillary zone electrophoresis (CZE), and/or other CE methods in the first dimension with LC in the second dimension, namely the ability to limit the degree to which physicochemically similar molecular species elute into adjacent fractions from the first dimension separation.

For example, proteomics platforms which combine capillary isoelectric focusing (CIEF) with nanoscale reverse-phase liquid chromatography (nano-RPLC) in a multidimensional separation system have been shown to enable ultrasensitive analysis of minute protein samples, as low as ng of total protein, extracted from targeted cells in tissue specimens. These platforms, however, employed an on-line approach to coupling the two separation dimensions. Valves were used to connect the CIEF capillary to one or more trap columns which held the concentrated molecules before being transferred to a RPLC capillary. The trap columns served to maintain the concentration of sample after CIEF and prior to injection into the LC column. However, even if sample fractions eluted from the CIEF capillary are diluted prior to LC, the LC column itself re-concentrates the molecules due to the phenomena of head column stacking. The present invention replaces the trap columns and complex valving systems with one or more structures such as, for example, a simple titer plate, a plurality of sample vials, or other structures that capture molecules eluted off the CIEF capillary. Analytes can be diluted during deposition (e.g., by the use of sheath liquid) and/or through any processing steps required prior to LC, and then re-concentrated as the analyte enters the head of the LC column, thereby mitigating the disadvantages associated with sample dilution during off-line interfacing. Because of the nature of electrokinetic separation modes such as, for example, CIEF, CITP, or other CE methods, the separated molecules retain the important feature of generally appearing in only a single LC fraction whether those fractions are captured on-line in a trap column or off-line on a titer plate. In addition, the use of the off-line format allows the fraction collection to be done to chromatographic resin enabling additional sample preparation prior to LC. Furthermore, titer plates or other structures exhibiting very low sample adsorption are commercially available (384-well PCR plates from Bio-Rad Laboratories), mitigating the disadvantages of sample loss which would otherwise be present during off-line interfacing.

A further perceived disadvantage of off-line interfacing is that typical autosamplers used for loading sample from a titer plate or other structure into a capillary are not generally designed to ensure complete sample removal from the titer plate, and thus sample loss can occur. However, sample loss can be eliminated through the use of custom-programmed autosampler loading methods which take into account the volumes present in the injection needle, the sample loop, and port-to-port valve volumes. By taking these volumes into consideration, an autosampler may be programmed to deliver the entire contents of a titer well or other structure to an appropriately sized sample loop.

Results obtained from either on-line or off-line methods are comparable in terms of separation performance and detection sensitivity. For example, an on-line CIEF-nRPLC-MS/MS analysis observed 76% of peptides to be present in a single fraction, whereas an off-line CIEF-nRPLC-MS/MS analysis of the same sample observed 74% of peptides to be present in a single fraction. Additionally, these two separations yielded 2,617 and 2,734 protein identifications, respectively.

The use of the term “capillary” in this invention is not meant to be restrictive to standard fused silica capillaries, but can also refer to plastic capillaries or microchannels contained within a microfluidic device. In fact, there may be advantages to implementing certain aspects of the invention in a multidimensional microfluidic system rather than in silica capillaries.

The invention provides methods for multi-dimensional separation and concentration of biochemical samples combining a first-dimension CE separation, a second-dimension LC separation, and an off-line transfer between the first and second dimensions. For example, the invention provides for CE-LC separations such as, for example, the combination of CIEF-RPLC, CITP-RPLC, CITP/CZE-RPLC, or other combinations of capillary electrophoresis and liquid chromatography that utilize an off-line, rather than on-line, approach.

The invention utilizes lower complexity off-line methods for the transfer of analytes between orthogonal separation techniques, while maintaining sample concentration and ensuring complete sample transfer. Off-line transfer also enables treatment/preparation of analytes between separation dimensions and provides other advantages.

In one embodiment, the invention includes performing a first dimension separation on a heterogeneous biomolecular sample to produce multiple sample fractions. In some embodiments, capillary isoelectric focusing (CIEF) may be performed to separate proteins or other peptides in the first dimension.

In some embodiments, the invention includes performing a first dimension separation based on transient capillary isotachophoresis (CITP) or transient capillary isotachophoresis/capillary-zone electrophoresis (CITP/CZE). Transient CITP/CZE refers to a process in which CITP occurs at the beginning of the separation and transitions to CZE as the leading electrolyte exits the separation capillary. The use of CITP or CITP/CZE enables selective concentration of trace compounds for enhanced low abundance protein analysis, less sensitivity to protein or peptide precipitation during sample stacking due to the charged nature of sample components, and potentially greater coverage of peptides/proteins with extreme pI values. Additional information regarding CITP and/or CITP/CZE can be found in co-pending U.S. Patent Application No. (Attorney Docket No. 016474-0358903), entitled “Methods and Systems for Multidimensional Concentration and Separation of Biomolecules using Capillary Isotachophoresis,” which is hereby incorporated by reference herein in its entirety.

In addition, CITP/CZE offers benefits for proteome analysis from samples such as formalin-fixed paraffin-embedded tissues. Because analyte recovery is part of the separation step in CITP/CZE, uncharged species do not mobilize and therefore do not leave the capillary. This provides CITP/CZE-LC-MS/MS a greater tolerance for such species, which can include common contaminants resulting from typical sample preparation procedures such as plastic polymers from storage containers, as well as polyethylene glycol and paraffin waxes, both widely used tissue preservatives. This allows for fewer sample preparation procedures prior to CITP/CZE. CITP/CZE-LC-MS/MS also reduces matrix effects commonly seen in the electrospray ionization and mass spectrometric ion detection processes from such contaminants.

CITP/CZE may provide a higher resolution separation than other methods when separating complex peptide mixtures, and thus less overlapping between sequential fractions eluted from the CITP/CZE capillary. This results in higher numbers of peptide sequences detected and identified and, consequently, higher numbers of proteins inferred.

After the sample is separated in the first dimension, the sample fractions are deposited onto one or more structures such as, for example, a titer plate, a plurality of sample vials, or other structures that enable the fractions to be held separate from one another. Use of the one or more structures also enables treatment and/or preparation of the multiple fractions such as, for example, subjecting the fractions to non-eluting conditions prior to separation in the second dimension. These and other treatments may, inter alia, ensure proper head column stacking when liquid chromatography is performed in the second dimension. Head column stacking concentrates sample fractions that may have become diluted during transfer and which may ensure that the fractions are separated based on desired characteristics.

The sample fractions may then be transferred to a second dimension separation medium such as, for example, a capillary reversed-phase liquid chromatography (CRPLC) apparatus, wherein each sample fraction may be separated into a plurality of sub-fractions. The separated sub-fractions may then be subject to eluting conditions and eluted from the second dimension separation apparatus. As each sub-fraction is eluted from the apparatus, the sub-fraction may be collected and/or analyzed, using, for example, mass spectrometry, to determine the sample constituents of the sub-fraction.

These and other objects, features, and advantages of the invention wilt be apparent through the detailed description and the drawings attached hereto. It is also to be understood that both the foregoing general description and the following detailed description are exemplary and not restrictive of the scope of the invention.

### BRIEF DESCRIPTION OF THE DRAWINGS

FIG. 1 illustrates an example of a process for off-line multidimensional separation of biomolecules.

FIG. 2 illustrates an example of a system for off-line multidimensional separation of biomolecules.

### DETAILED DESCRIPTION

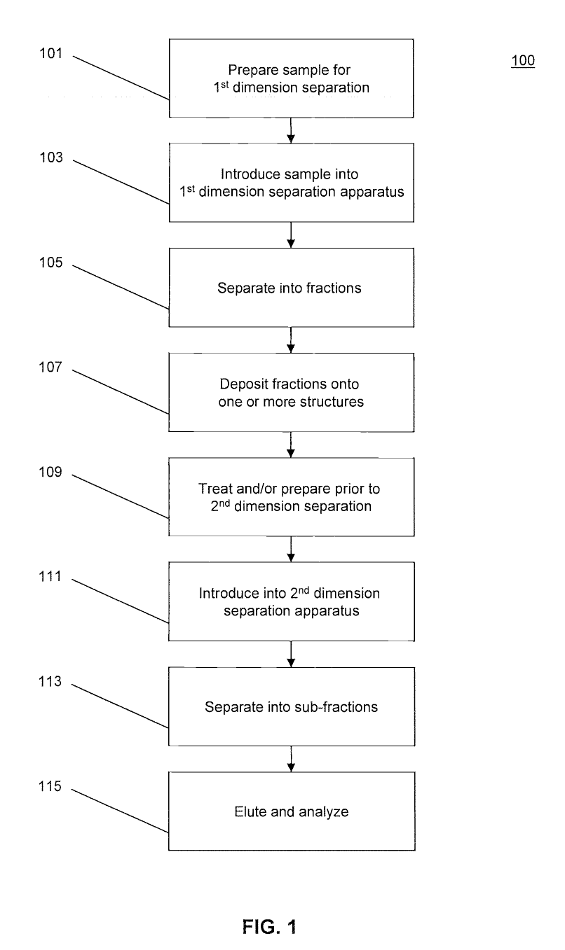

FIG. 1 illustrates a process 100 for performing off-line multidimensional separation of heterogeneous biomolecular samples. An example of heterogenous biomolecular samples as used herein may include a heterogeneous sample of proteins or other peptides (e.g., peptides and polypeptides) such as, for example, those prepared in Jinzhi Chen et al., Capillary Isoelectric Focusing-Based Multidimensional Concentration/Separation Platform for Proteome Analysis, Analytical Chemistry, Vol. 75, No. 13, July 2003.

Process 100 includes an operation 101, wherein a heterogeneous biomolecular sample may be prepared for multi-dimensional separation and analysis. Operation 101 may include one or more preparation techniques designed to facilitate first dimension separation, second dimension separation, analysis of sample constituents, and/or other operations. For example, if the biomolecular sample comprises a mixture of proteins and/or peptides, the sample may be treated with a detergent such as, for example, sodium dodecyl sulfate (SDS) or other detergent, to denature proteins, dissolve proteins, and/or otherwise treat proteins prior to separation and/or analysis.

In some instances, the presence of detergents, such as SDS, in protein samples is thought to interfere with certain separation techniques (e.g., capillary isoelectric focusing [CIEF], reversed-phase liquid chromatography [RPLC]). As such, in some embodiments, operation 101 may include an electrodialysis procedure after any treatment of the biomolecular sample with detergent to remove any free (i.e., unbound to protein or peptides) detergent molecules in the sample.

Electrodialysis may be performed by placing a biomolecular sample with detergent present into a chamber, wherein the chamber includes an open-ended cylinder whose ends are sealed with dialysis membrane such that the solution containing the sample will be retained within the chamber. The dialysis membrane used is chosen on the basis of its porosity in conjunction with the molecular weight of the detergent or other compounds to be removed by dialysis. The chamber is submerged into a tank filled with a buffer appropriate to the sample and to the electrodialysis procedure. The tank comprises a chamber holder and two electrodes. The tank electrodes are connected to the negative and positive leads, respectively, of an external power supply. The power supply supplies a current to the tank which causes charged species with a molecular weight lower than that of the dialysis membrane's cutoff limit to exit the chamber according to the principles and limits of osmosis.

In some embodiments wherein CIEF is used as a first dimension separation technique, the carrier ampholytes employed in CIEF may compete with and replace detergents (such as SDS) that are bound to proteins and peptides. This replacement effect not only allows the separation of peptides in CIEF based on their differences in isoelectric point (pI), but eliminates potential interference of detergents in any second separation and subsequent analytical processes. As such, in some instances, the use of CIEF as a first dimension separation technique may be desirable.

Process 100 includes an operation 103, wherein the heterogeneous biomolecular sample is introduced into a first dimension separation apparatus. As discussed herein, the apparatus used for the first dimension separation may depend on the characteristics selected for in the first dimension, the separation range needed, the acceptable error rate, the convenience of the apparatus in conjunction with other factors, and/or other factors.

In an operation 105, the first dimension separation apparatus may be used to separate the heterogeneous biomolecular sample into a plurality of fractions based on one or more characteristics of the fractions. For example, the first dimension separation apparatus may comprise a capillary electrophoresis apparatus. In one embodiment, the capillary electrophoresis apparatus may comprise a capillary isoelectric focusing (CIEF) apparatus, which separates samples based on isoelectric point. In some applications, CIEF may be desirable in that the entire volume of the capillary is loaded with sample, rather than a small injection of volume at the head of capillary. which is typical with some CE methods. The loading limitations associated with some CE formats may not be present with CIEF. These loading limitations that may have generally prevented the use of CE as a first-dimension separation medium in conjunction with the use of liquid chromatography (LC) as a second-dimension separation medium.

In some embodiments, the CIEF apparatus may include a pH gradient that has been established in the volume of a capillary. The upper and lower boundaries of the pH gradient may vary, depending on the resolution desired for the fractioning of the biomolecular sample and/or other factors. Varying catholytes and anolytes may be employed accordingly.

During separation of the heterogenous biomolecular sample using CIEF, an electric current is applied across the capillary, thus motivating various constituents within the sample to migrate to their respective isoelectric point's (pI's) along the pH gradient. As the constituents migrate, the current running through the capillary will decrease. The decrease in current occurs as ions with isoelectric points outside of the pH range defined by the anolyte and catholyte exit the capillary and as the ions migrate to their isoelectric point at which they possess zero net charge (therefore increasing resistance across the capillary). The isoelectric focusing separates the heterogeneous biomolecular sample into the plurality of fractions, wherein the molecules within each fraction have the same or similar isoelectric point.

In one embodiment, the first dimension separation apparatus may comprise a capillary isotachophoresis (CITP) apparatus or a capillary isotachophoresis/capillary-zone electrohporesis (CITP/CZE) apparatus, which separate biomolecular samples based on size and/or charge. The CITP or CITP/CZE apparatus may include a capillary wherein a separation media resides. During separation of the biomolecular sample using CITP or CITP/CZE, an electric current is applied across the capillary, thus motivating the sample constituents to migrate through the separation media based on size and charge. CITP or CITP/CZE is accomplished by loading a sample into a capillary pre-filled with a buffer (0.1 M acetic acid) by either pressure of electrokinetic means, such that the capillary is partially filled with sample. When using a CITP/CZE apparatus, the degree to which the capillary is filled with sample will affect the transition point from CITP to CZE and thus influence the separation. The ends of the capillary are then connected to vials or flows containing the buffer (0.1 M acetic acid) and a positive current is supplied to the inlet end while the outlet end is connected to ground. This current motivates the separation.

Other electrokinetic separations may be used to separate the heterogeneous biomolecular sample into a plurality of sample fraction. For example, capillary gel electrophoresis (CGE), micellar electrokinetic chromatography (MEKC), capillary electromatography (CEC) or other electrokinetic separations or combinations thereof, may be used.

In the first dimension CE separation, the capillary inner diameter may affect separation performance. A large capillary diameter can lead to the generation of excessive Joule heating, while a small capillary diameter can significantly limit the amount of sample molecules which may be loaded into the apparatus. As such, in some embodiments, a silica capillary having an inner diameter of around 100 microns may be used to enable sufficient sample loading for highly sensitive detection of analyte molecules while limiting the heat generation below a level which would lead to excessive molecular dispersion during the CE separation. In some embodiments, the electrophoresis capillary may be coated with a material designed to reduce electroosmotic flow, such as hydroxypropyl cellulose.

In an operation 107, the one or more separated sample fractions are deposited onto one or more structures, wherein the one or more structures enable each fraction to be held separate from other fractions. For example, the one or more structures may include the wells of a multi-well titer plate, a plurality of centrifuge tubes, a plurality of sample vials, adsorbent media, and/or other structures, wherein individual sample fractions may be held separate from one another.

Deposition of the sample fractions onto the one or more structures may vary depending on the type of first dimension separation technique used or other conditions. For example, in some embodiments any electric current motivating first-dimension separation may be disconnected prior to deposition of the fractions onto the one or more structures. Deposition may be accomplished by forcing each fraction out of the capillary using hydrodynamic pressure. In some embodiments, the electric current motivating separation may be allowed to continue, thus moving the fractions out of the separation capillary onto the one or more structures. This may be accomplished through the use of a sheath flow in which a flow coaxial to the to the separation capillary is used to maintain an electrical circuit while simultaneously allowing for collection of the separated sample from the outlet end of the capillary together with the sheath flow components.

Unlike direct (“on-line”) transfer between separation mediums, deposition of sample fractions onto the one or more structures according to the invention enables, inter alia, convenient treatment and/or preparation of the multiple fractions prior to separation in the second dimension. Such treatment and/or preparation of the sample fractions may be performed in an operation 109. Treatment or preparation of sample fractions may include removing incompatible or undesirable elements remaining from the first dimension separation (e.g., buffer, separation media, etc), conditioning the sample fractions for optimal second dimension separation, and/or other operations.

For example, in one embodiment, separation in the second dimension may comprise separation in a capillary reversed-phase liquid chromatography (CRPLC) apparatus based on hydrophobicity of the molecules in the fractions. As such, the fractions may be subject to “non-eluting” conditions while in the one or more structures to ensure proper head column stacking and separation based on hydrophobicity in the second dimension separation apparatus.

To achieve non-eluting conditions in CRPLC, the sample fractions may be titrated to an acidic pH (e.g., pH 2-3) to ensure proper head column stacking. Proper head column stacking may be necessary to concentrate sample fractions that may have become diluted during transfer. An ion-pairing reagent may also be added to the sample fractions. The ion-pairing reagent binds to molecules which are positively charged (e.g., the ion-pairing reagent binds to positively charged peptides) to ensure that the samples separate based on hydrophobicity. In one embodiment, trifluoroacetic acid (0.1%-1.0%) may be added to the sample fractions to both titrate the fractions to an acidic pH and to serve as an ion-pairing reagent. Other treatments may be used to bring the sample fractions into non-eluting conditions. Other preparations/treatments may be performed while the sample fractions are in the one or more structures.

In some instances, sample fractions that are deposited onto the one or more structures such as, for example, a titer plate, may dry out when exposed to air. As such, in some instances, sample fractions deposited onto the one or more structures may be quickly covered following deposition and/or a layer of oil, glycerine, or other protective substance may be applied to the surface of the sample fractions.

In some instances, sample fractions that are deposited onto the one or more structures such as, for example, centrifuge tubes or a titer plate, may then be placed into a centrifuge with lyophilization capabilities so as to evaporate the sample to dryness This step allows for a sample to be reconstituted in a media compatible with the subsequent separation and/or analysis.

In some situations, biochemical samples may adsorb to the surface of the one or more structures, thus preventing transfer of the complete sample fraction to the second separation media. As such, in some embodiments, the one or more structures (e.g., titer plates, vials, or other surfaces) may be constructed of low-adsorption materials. These materials are typically hydrophilic plastics which are available from a variety of manufacturers and are marketed as having “low-protein binding” properties.

In an operation 111, the sample fractions may be transferred from the one or more structures to the second dimension separation apparatus. In one embodiment, the second dimension separation apparatus may comprise, for example, one or more capillary reversed-phase liquid chromatography columns, wherein each sample fraction may be separated into a plurality of sub-fractions based on hydrophobicity. Other second dimension separation techniques that separate samples based on other properties may also be used, for example, strong cation exchange (SCX) chromatography, normal phase liquid chromatography (NPLC), hydrophilic interaction liquid chromatography (HILIC), size exclusion chromatography (SEC), or other chromatographic technique or combination thereof may be used.

In some embodiments, the second dimension separation apparatus may comprise a nanoscale LC apparatus. Compared to traditional microscale LC, nano-LC uses a smaller diameter capillary with smaller overall volumes. In some embodiments, the LC capillary is a silica capillary having an inner diameter of about 50 microns. In some embodiments, the LC capillary is a silica capillary having an inner diameter of about 25 microns. The smaller capillary volume leads to higher sample concentrations, while nanoscale flow rates (typically 100-200 nL/min) allow electrospray ionization—mass spectrometry (ESI-MS) to be performed from the nano-LC column with the MS operating in a concentration-dependent regime. Furthermore, nano-LC volumes are compatible with first dimension CE separations performed in small diameter capillaries. Traditionally, CE is used as a second dimension separation mode following LC because of the relatively low loading capacity in CE as compared to LC. By taking multiple LC fractions, the total sample amount loaded into each CE separation can be made more compatible with CE. By employing nano-LC instead of microscale LC, the loading requirements of the two separation dimensions become comparable, enabling more effective nano-LC analysis of multiple fractions collected from a first dimension CE separation.

In one embodiment, the second dimension separation of two or more of the sample fractions may take place in parallel such as, for example in an array of second dimension separation capillaries. In other embodiments, each of the sample fractions may be separated in series. For example, each sample fraction may be loaded sequentially into a single second dimension separation capillary.

In some embodiments, the transfer from the one or more structures may be accomplished using an automated robotic transfer apparatus such as, for example, an autosampler, or other apparatus. In one implementation, an autosampler may aspirate a sample fraction from the one or more structures (e.g., the wells of a titer plate) and expel the sample into, for example, the loading chamber or injection system of a reversed-phase liquid chromatography apparatus or into a loading element of another apparatus used for second dimension separation.

In some fluid transfer applications, autosamplers or other robotic sample transfer mechanisms fail to transfer 100% of the sample, introduce air into the separation medium, and/or pose other problems. As such, precision and/or custom programs may be used with robotic transfer mechanisms to ensure 100% transfer of samples with no air introductions or other problems. For example, sample loss can be eliminated through the use of custom-programmed autosampler loading methods which take into account the volumes present in the injection needle, the sample loop, and port-to-port valve volumes. By taking these volumes into consideration, an autosampler may be programmed to deliver the entire contents of a titer well or other structure to an appropriately sized sample loop.

In some embodiments, transfer of sample fractions from the solid support to the second dimension separation apparatus may utilize manual transfer techniques other than or in addition to robotic transfer mechanisms (e.g., hand pipetting), or other transfer techniques or elements.

In an operation 113, after transfer into the second dimension separation apparatus, each of the sample fractions may be separated into a plurality of sub-fractions (to the extent possible) according to the one or more characteristics selected for by the second dimension separation apparatus. As mentioned above, in some embodiments, the second dimension separation apparatus may include a capillary reversed-phase liquid chromatography (CRPLC) apparatus. In some embodiments, the CRPLC apparatus may comprise, for example, a fused silica capillary packed with C₁₈-bonded particles, wherein the sample fractions are separated into sub-fractions based on hydrophobicity. As described herein, in some embodiments, nanoCRPLC may be used. In some embodiments, separation into sub-fractions according to hydrophobicity may be performed at a bulk flow rate of between 100-200 nL/min. In some embodiments, separation into sub-fractions according to hydrophobicity may be performed at a bulk flow rate of below 100 nL/min.

In an operation 115, the separated sub-fractions may be subject to eluting conditions and eluted from the second dimension separation apparatus. As each sub-fraction is eluted from the apparatus, the sub-fraction may be collected and analyzed, for example, using mass spectrometry (e.g. ESI-MS or MALDI-MS), to determine the sample constituents of the sub-fraction. In one embodiment, mass spectroscopic analysis of proteins and other peptides may be assisted by one or more algorithms such as, for example SEQUEST or other algorithms or analysis to determine the amino acid sequence of individual protein or peptide constituents of the sub-fractions.

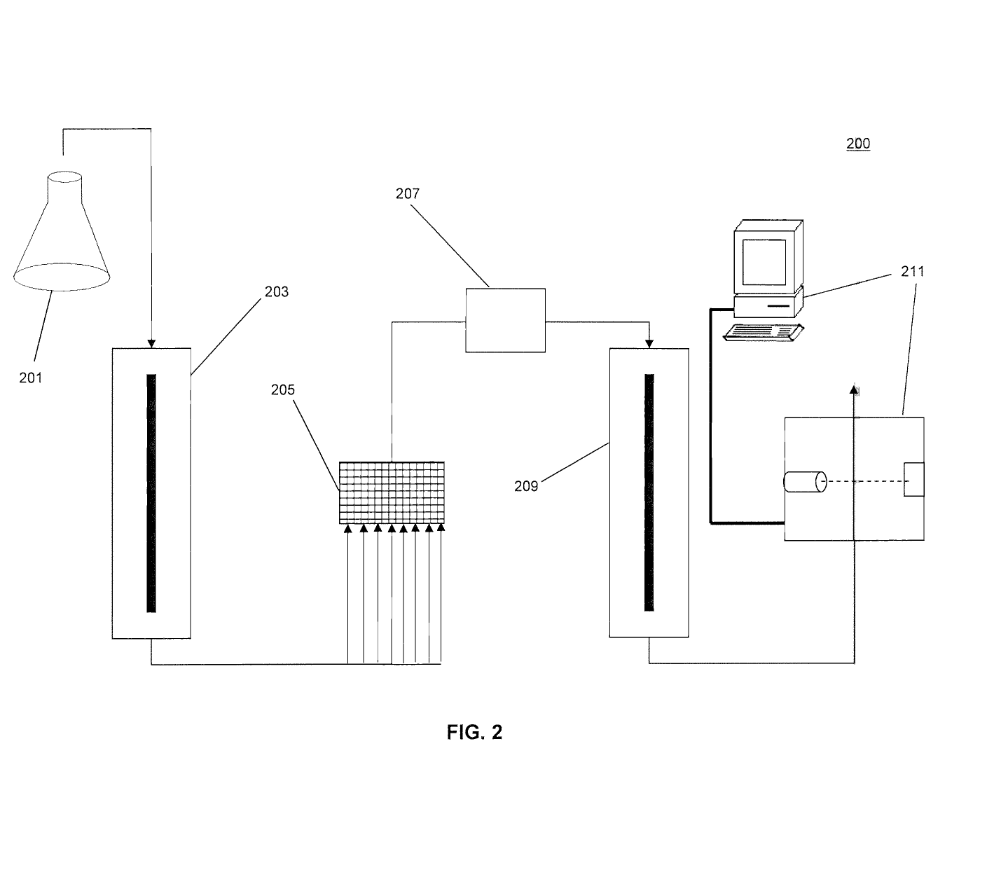

FIG. 2 illustrates an example of a system 200 for oft-line multidimensional separation of heterogeneous biomolecular samples, such as, for example, proteins and other peptides. In one embodiment, system 200 may include initial sample preparation elements 201 for preparation of a heterogeneous biomolecular sample. Preparation of the sample may include equipment and techniques known in the art, such as those described in Chen et al. Initial sample preparation elements 201 may also include any elements necessary to treat the heterogeneous sample with SDS, to perform electrodalysis, and/or to perform any other preparation operations.

System 200 may also include a first dimension separation apparatus 203. For example, in some embodiments, the first dimension separation apparatus may include a CIEF apparatus, such as that used in Jinzhi Chen et al. In other embodiments, first dimension separation apparatus 203 may include a CITP apparatus, a CITP/CZE apparatus, or other capillary electrophoresis apparatus.

System 200 may also include one or more structures 205 whereupon separated sample fractions may be deposited, such that the sample fractions are kept separate from one another. In some embodiments, one or more structures 205 may include a multi-well titer plate (e.g., a 96 well, 384 well, or other titer plate), a plurality of centrifuge tubes, a plurality of sample vials, or other structures. In some situations, biochemical samples may adsorb to the one or more structures 205, thus preventing transfer of the complete sample fraction to the second dimension separation apparatus. As such, in some embodiments, one or more structures 205 may be constructed of low-adsorption materials.

System 200 may also include a transfer apparatus 207, which may include an autosampler (e.g., Sparks-Holland™), a hand pipette, or other elements for transferring fractions from one or more structures 205 to the second dimension separation apparatus.

System 200 may also include a second dimension separation apparatus 209 for separating the sample fractions into one or more sub-fractions. As discussed herein, second dimension separation apparatus 209 may include a RPLC apparatus, such as those used in Jinzhi Chen et al. Other second dimension separation apparatuses may be used.

System 200 may also include an analysis apparatus 211 for detecting/analyzing the constituents of the sub-fractions produced by second dimension separation apparatus 209. In one embodiment, analysis apparatus may include a mass-spectroscopy apparatus and associated computer system for analysis of mass spectroscopic results.

Other embodiments, uses and advantages of the invention will be apparent to those skilled in the art from consideration of the specification and practice of the invention disclosed herein. The specification should be considered exemplary only, and the scope of the invention is accordingly intended to be limited only by the following claims.

We claim:

1. A method for performing a multi-dimensional separation and analysis of a heterogeneous biomolecular sample, the method comprising:
introducing the heterogeneous biomolecular sample into an electrophoresis capillary;
separating the heterogeneous biomolecular sample into a plurality of fractions;
depositing the plurality of fractions onto one or more structures, wherein the one or more structures maintain each of the plurality of fractions separate from one another;
introducing at least one of the plurality of fractions into at least one liquid chromatography capillary;
concentrating the at least one of the plurality of fractions at a first end of the at least one liquid chromatography capillary;
separating the at least one of the plurality of fractions into a plurality of sub-fractions using the at least one liquid chromatography capillary; and
eluting each of the plurality of sub-fractions from a second end of the at least one liquid chromatography capillary.

2. The method of claim 1, wherein depositing the plurality of fractions onto one or more structures further comprises subjecting the at least one of the plurality of fractions to non-eluting conditions by titrating the at least one of the plurality of fractions to an acidic pH and adding an ion-pairing reagent to the at least one of the plurality of fractions.

3. The method of claim 2, wherein titrating the at least one of the plurality of fractions to an acidic pH further comprises adding trifluoroacetic acid to the at least one of the plurality of fractions.

4. The method of claim 2, wherein adding an ion-pairing reagent further comprises adding trifluoroacetic acid to the at least one of the plurality of fractions.

5. The method of claim 2, wherein titrating the at least one of the plurality of fractions to an acidic pH comprises titrating the at least one of the plurality of fractions to a pH of between 1 and 4.

6. The method of claim 2, wherein titrating the at least one of the plurality of fractions to an acidic pH comprises titrating the at least one of the plurality of fractions to a pH of between 2 and 3.

7. The method of claim 1, wherein the heterogeneous biomolecular sample comprises a heterogeneous sample of one or more of peptides and polypeptides.

8. The method of claim 7, further comprising treating the heterogeneous sample of proteins with a detergent prior to introducing the heterogeneous sample of proteins into the electrophoresis capillary.

9. The method of claim 1, wherein the electrophoresis capillary comprises a capillary for performing capillary isoelectric focusing, and the heterogeneous biomolecular sample is separated into the plurality of fractions based on isoelectric point.

10. The method of claim 1, wherein the electrophoresis capillary comprises a capillary for performing capillary isotachophoresis, and the heterogeneous biomolecular sample is separated into the plurality of fractions based one or more of size or charge.

11. The method of claim 1, wherein the electrophoresis capillary comprises a capillary for performing an electrokinetic separation based on one of:
transient capillary isotachophoresis/capillary zone electrophoresis (CITP/CZE), capillary isotachophoresis (CITP), capillary zone electrophoresis (CZE), capillary gel electrophoresis (CGE), micellar electrokinetic chromatography (MEKC), or capillary electrochromatography (CEC).

12. The method of claim 1, wherein the one or more structures comprise a titer plate.

13. The method of claim 1, wherein the one or more structures comprise a plurality of sample vials.

14. The method of claim 1, wherein the at least one liquid chromatography capillary comprises a capillary for performing a liquid chromatography separation based on one of: reversed-phase liquid chromatography (RPLC), strong cation exchange chromatography (SCX), normal-phase liquid chromatography (NPLC), hydrophilic interaction liquid chromatography (HILIC), or size exclusion chromatography (SEC).

15. The method of claim 1, wherein the at least one liquid chromatography capillary comprises a nano-reversed-phase liquid chromatography capillary.

16. The method of claim 1, further comprising identifying constituent biomolecules of each of the sub-fractions.

17. The method of claim 16, wherein identifying constituent biomolecules of each of the sub-fractions further comprises analyzing the plurality of sub-fractions using mass spectrometry.

18. The method of claim 17, wherein mass spectrometry comprises electroscopy ionization-mass spectrometry (ESI-MS).

19. The method of claim 1, wherein the electrophoresis capillary is a silica capillary possessing an inner diameter of about 100 microns.

20. The method of claim 1, wherein the electrophoresis capillary is a silica capillary coated with a material designed to reduce electroosmotic flow.

21. The method of claim 1, wherein the liquid chromatography capillary is a silica capillary possessing an inner diameter of about 50 microns.

22. The method of claim 1, wherein the liquid chromatography capillary is a silica capillary possessing an inner diameter of about 25 microns.

23. The method of claim 16, wherein separating the at least one of the plurality of fraction into a plurality of sub-fractions according to hydrophobicity is performed at a bulk flow rate of between 100-200 nL/min.

24. The method of claim 16, wherein separating the at least one of the plurality of fractions into a plurality of sub-fractions is performed at a bulk flow rate below 100 nL/min.
